(19) United States
(12) Patent Application Publication
(10) Pub. No.: US 2015/0193455 A1
(43) Pub. Date: Jul. 9, 2015

(54) METHOD OF RECORDING INFORMATION REGARDING A PLOT OF LAND

(71) Applicant: Michael Koenig, Lone Tree, IA (US)

(72) Inventor: Michael Koenig, Lone Tree, IA (US)

(21) Appl. No.: 14/150,838

(22) Filed: Jan. 9, 2014

(51) Int. Cl. G06F 17/30

(52) U.S. Cl. CPC G06F 17/3089; G06F 17/30241

(57) ABSTRACT

A method of recording information regarding a plot of land that includes establishing a polygon boarder with a handheld device and identifying a condition within the polygon boarder associated with the plot of land. Information about the condition is then determined with the handheld device and that information is stored at a website with the handheld device.

### BACKGROUND OF THE INVENTION

This invention relates to a crop and field maintenance. More specifically, this invention relates to a method of recording field information.

When maintaining crops an individual must survey a plot of land or field by walking through the field and identifying problem conditions in the field such as weeds, insects, land, herb, natural and nutrient deficiencies or other disorders or diseases. Then an individual must take the information gathered and do research in an attempt to determine what type of weed, insect, disorder, disease or the like is on the plot of land. Only then can an individual determine what type of herbicide, insecticide or treatment must be used in order to prepare the land for planting.

This process is time consuming and inaccurate. In addition, the fields that are to be planted are typically vast in area and finding the locations of different conditions such as weeds, insects, disorders or diseases can be difficult unless recorded precisely upon the original walk through. Thus, a need in the art exists for identifying such conditions such as weeds, insects, disorders and diseases and recording this information so that the information can be utilized to help treat such conditions.

In addition, oftentimes just treating a problem or condition such as a weed, insect, disorders or diseases is insufficient. Specifically, it is often difficult to diagnose why a certain insect or weed may be at certain locations. For example, in certain geographical locations specific insects exist and thus this may explain why an insect is found on a plot of land. However, in other circumstances such insects may not be common to a certain area at which point in time knowledge of this information would allow an individual to realize there must be some secondary reason for the insect being on the plot of land. In this manner by having additional information regarding other plots of land in a similar geographic region assists in diagnosing what is causing certain conditions to occur. Currently such information is not available. While an individual may keep records and logs regarding their own land, there is not an effective way of determining if other similarly situated fields are experiencing similar problematic conditions other than word of mouth.

Thus, a principle object of the present invention is to provide an efficient manner of identifying conditions within a plot of land.

Yet another object of the present invention is to assist in the diagnosis of problems associated with a plot of land.

These and other objects, features, and advantages will become apparent from the specification and claims.

### BRIEF SUMMARY OF THE INVENTION

A method of recording information regarding a plot of land with a handheld device. The method includes identifying a condition within a polygon border associated with the plot of land and determining information about the condition with the handheld device. At that point in time the information is recorded at a website with the handheld device.

### BRIEF DESCRIPTION OF THE DRAWINGS

FIG. 1 is a schematic diagram of a field surveying system;

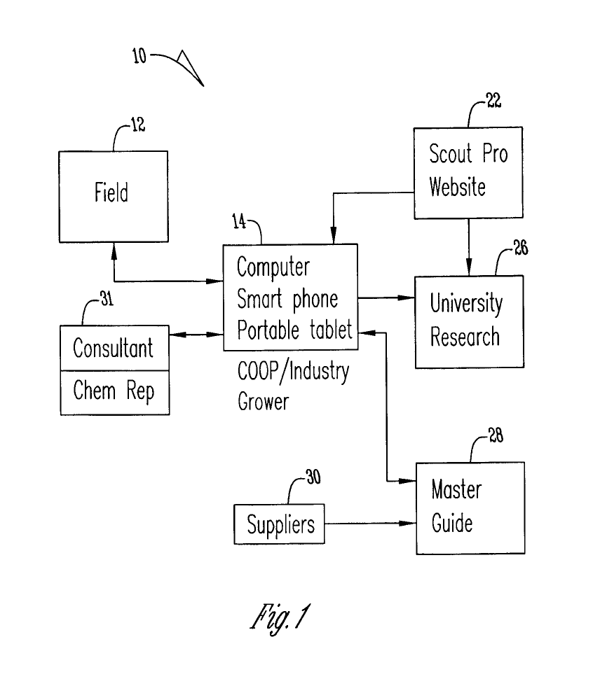

FIG. 2 is a schematic diagram of a plot of land utilizing a land surveying system; and

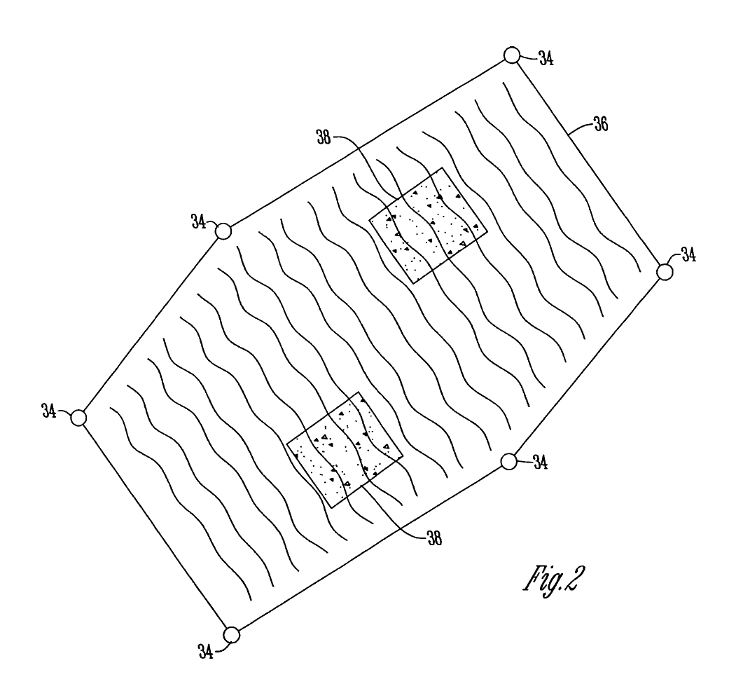

FIG. 3 is a schematic diagram of a hand held device for a field surveying system.

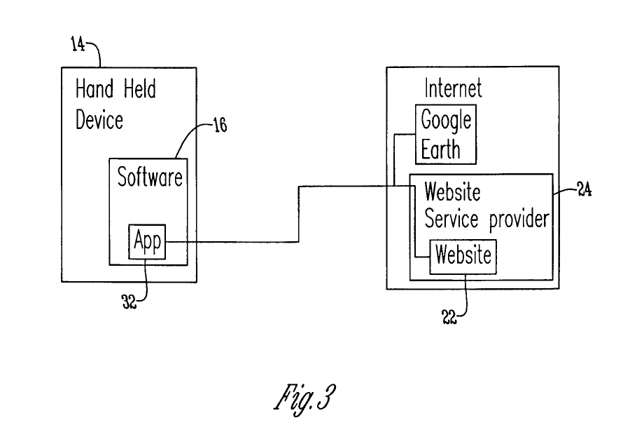

### DETAILED DESCRIPTION OF THE PREFERRED EMBODIMENT

The figures show a field surveying system 10 for surveying a plot of land 12 or field utilizing a handheld device 14. The plot of land 12 can be any field used to grow any type of agricultural crop, including, but not limited to corn, tobacco, cotton, wheat, soybean and the like. The handheld device 14 is any portable device such as a tablet, Smartphone, laptop computer, iPad, or the like that additionally has software 16 and can access the internet 18. The field surveying system 10 also includes a website 22 maintained by a website service provider 24 that accesses and controls the website 22 from a computer.

The website service provider 24 is in communication with a research entity 26 such as a University database that provides information and data to the website 22 in the form of guides and is in communication with the handheld device 14. The guides, which contain images and information, are stored in a database associated with the website 22. Similarly, the handheld device 14 is in communication with and forms a master guide 28 that is in communication or can be accessed by suppliers 30 to provide additional information to the handheld device 14. The handheld device is also in communication with consultants 31 and chemical reps that can also provide additional information instantaneously to an individual in a field 12.

A downloadable software application 32 is provided to the handheld device 14 to allow communication with the website 22. The software application 32 can be presented as a favorite on the handheld device 14 providing quick access. Further, the software program functions to allow information to be inputted into the hand held device 14 and transmitted into the guides at the website 22 in real time. This includes, but is not limited to voice actuated information. In addition, the software application 32 can be associated with specific maps or geographical information such as Google Earth or GPS in order to identify the location of the handheld device 14 including providing exact longitudinal and latitudinal coordinates of the handheld device 14 at all times. Preferably the handheld device accesses via the internet both Google Maps and Shapefiles that create predetermined boundaries by mapping and geo spatial systems. In this manner as an individual walks around a field 12 the individual may provide drop pins 34 at the boundaries of the field that when dropped their exact location is recorded in order to provide a mapped polygon 36 that represents the field 12. As an individual walks about the field 12 they come upon different conditions 38 such as weeds, insects, disorders, diseases and the like. When such a condition 38 is encountered the location of the condition is inputted into the device 14 either manually or audibly to be recorded and sent to the website 22. Simultaneously the exact location, including the longitudinal and latitudinal coordinates are sent and recorded. Preferably, the Shapefile has three mandatory files that include a shape format, the shape index format, and the attribute format. Optional files may include a projection format, a spatial index of features, a spatial index of features that are read only, an attribute index of active fields, a geocoding index, geospatial metadata, or a code page for character encoding.

In addition, information regarding the condition 38 is inputted into the handheld device 14 to provide additional information to the website 22. At the same time an individual may receive information from the website regarding the condition 38. For example, if the condition 38 is a weed an individual can input this information into the handheld device 14 and a subset of different types of weeds then is provided by the website 22 to the handheld device 14. The individual can then select one of those subsets such as a grass and is then provided with another subset of characteristics. This can be done until the weed is identified by the individual in the field 12. At that point in time the exact type of weed and the location of the weed including longitudinal and latitudinal coordinates are recorded at the website 22.

Further, the individual may input information about the weed, such as its height and dimensions and add additional comments to add to the database records and guides at the website 22. In this manner the guides at the website 22 are updated in real time. Such guides can then be searched by others by name, crop type, disorder, index, letter, keyword or the like.

Thus the website database becomes a valuable resource for the industry. To that end the web service provider 24 can review over data and link tutorials and other helpful information to the website for use by an individual. For example, if the web service provider 24 recognizes an outbreak of a certain weed in a certain area a tutorial can be provided regarding the best ways to eliminate the weed. To this end suppliers 31 can supply information and links to the best herbicides for containing or eliminated such a weed.

In other applications the updated guides can be utilized to assist COOPs and growers in selling the right seeds and chemicals for achieving maximum yields. Industry sales information and recommendations can also be provided. For example, an individual that surveys a field and reports insects at a particular location in the field can later after the insects have been treated comment on the effect of the insecticide. Specifically, not only does a new survey of the location show how the insects have either increased in area or decreased, the individual can comment on what insecticide was used and their opinion on its effectiveness of the insecticide. Thus a grower referral system is provided.

In yet another application the updated guides can be used as an educational tool that is put in text books. Thus students can see the effects of different chemicals on different conditions 38. In addition maps can be formed using the guide information to show locations of certain conditions. 38.

Thus, in operation when an individual surveys a field, the individual establishes a polygon boarder 36 with the handheld device 14. In addition the individual inputs additional information such has crop type planted, or previously planted, or any other relevant information known to the individual to be presented in comments. At that point conditions 38 are identified within the polygon boarder 36 associated with the plot of land 12. Next, information about each condition 38 is determined with the handheld device 14 by actuating the website 22. Finally, the information regarding the condition 38, including location information, is recorded at the website 22 for future use. The information simultaneously is sent to consultants 31 and master guide 28 to provide additional information to entities that can assist the individual in handling the conditions 38.

Thus presented is a system and method of retrieving information about a field or plot of land 12. By utilizing the application software application 32 an individual surveying a field may instantaneously identify a condition 38 such as a weed, insect, disorder, disease or the like and the exact location within the field 12 of the condition 38. Simultaneously this information may be passed along to suppliers, consultants and the like so that they may begin providing suggestions of certain types of herbicides, insecticides or the like needed in order to treat the conditions 38.

In addition the website 22 provides and records aggregate geographic information regarding other plots of lands that are similarly situated to the plot of land being surveyed thus providing additional information that assists in diagnosing why a certain condition is occurring. For instance if a certain insect is prevalent to a certain geographic area, then when that insect is found on a plot of land 12 the individual surveying realizes this is a result of the geographic location of the plot of land 12. Whereas, if such insect is not prevalent in that geographic area then the individual surveying realizes that a secondary factor is causing the insect to locate themselves at that specific location. At this point in time an individual may attempt to discover why the insect is only presenting itself on their specific plot of land 12 in order to ensure that once exterminated the insect does not come back.

Another advantage of the system 10 is that as individuals survey fields 12, the information at the website is instantaneously updated and recorded. This provides updated information to be used by individuals and others that similarly use the system 10. Thus, at the very least all of the stated objectives have been met.

While the application has indicated the system 10 is utilized by an individual, this is done as an example only. The system 10 may be used by an individual at a COOP, in an industry, grower, farmer or the like without falling outside the scope of this disclosure.

What is claimed is:

1. Method of recording information regarding a plot of land steps comprising:
identifying a condition on a plot of land;
determining information about the condition with a handheld device; and
recording the information at a website with the handheld device.

2. The method of claim 1 wherein the condition is a weed.

3. The method of claim 1 wherein the condition is an insect.

4. The method of claim 1 wherein the condition is a disorder associated with the plot of land.

5. The method of claim 1 wherein the condition is a disease associated with the plot of land.

6. The method of claim 1 wherein drop pins are utilized to establish a polygon border.

7. The method of claim 1 further comprising the step of establishing the location of the condition when the condition is identified.

8. The method of claim 7 wherein longitudinal and latitudinal information is stored at the website.

9. The method of claim 1 wherein data about the condition is stored at the website.
